(19) United States
(12) Patent Application Publication
(10) Pub. No.: US 2012/0091865 A1
(43) Pub. Date: Apr. 19, 2012

(54) Power unit for an electrical steering system

(76) Inventors: Andreas Knoedler, Iggingen (DE); Stefan Walz, Schwaebisch Gmuend (DE); Harald Eberhardt, Stuttgart (DE); Faruk Capkin, Schwaebisch Gmuend (DE)

(21) Appl. No.: 13/135,270

(22) Filed: Jun. 30, 2011

Related U.S. Application Data
(63) Continuation of application No. PCT/EP2009/066304, filed on Dec. 3, 2009.

(30) Foreign Application Priority Data
Jan. 13, 2009 (DE) 10 2009 000 169.7

(51) Int. Cl. H02K 5/22; B23P 19/04; B23P 11/02

(52) U.S. Cl. 310/68 D; 29/447; 29/800

(57) ABSTRACT

Disclosed is a power unit for an electric steering system and a method for assembling such a power unit. The power unit comprises a motor and a control unit, wherein the control unit is connected to the motor by means of shrink fitting.

### BACKGROUND OF THE INVENTION

The invention relates to a power unit for an electric steering system, to a method for assembling such a power unit, and to a joining apparatus for a power unit.

In electric steering systems, assistance torque is generated using a power unit or a power pack, which constitutes a unit comprising a motor and control unit. To this end, a large amount of heat develops in the control unit (ECU) due to switching and transmission losses, notably at the output stage. The output stage typically comprises power semiconductors, and so as to protect the output stage from damage, the maximum depletion layer temperature of power semiconductors must not be exceeded. The heat from the control unit is dissipated by the motor. The heat flows from the output stage, via a base plate and the motor flange, into the motor housing.

The greatest heat emission from the output stage typically occurs only over very short time periods, which is to say periods of a few seconds. For this reason, particularly good local heat dissipation is required at the output stage, so that the heat can be discharged as quickly as possible by high level dissipation of energy over a short period of time, and so that the base temperature of the base plate is as low as possible. For this reason, the thermal resistance at the motor flange must be as low as possible.

It is known to screw the control unit onto the motor housing. In a screw assembly of the control unit and motor according to the prior art, heating occurs only locally at the screw sites, which is to say the pressing surfaces of the screw assembly. Electrical connection of the motor and control unit is typically established by plug contacts.

### SUMMARY OF THE INVENTION

In the power unit for an electric steering system presented, in which the power unit comprises a motor and a control unit, the control unit is connected to the motor by means of shrink fitting. This eliminates the screw assembly process.

This shrink fitting ensures a large contact surface between the control unit and motor, and close or firm pressing of the adjoining surfaces against one another. This ensures good heat transfer between the control unit and the motor.

In one embodiment, the control unit is connected to a housing of the motor. This motor housing typically comprises a protrusion, such as, for example, a peripheral flange, in which the control unit can be inserted. In this way, the control unit is rigidly connected to the motor housing, and thus to the motor.

In the power unit, the housing of the motor may be made of die cast aluminum. Good heat conductance and ease of processing make this material suitable.

The control unit can further comprise a base plate. Typically, a control unit output stage, which predominantly generates heat, is disposed thereon. In this case, the base plate of the control unit is typically connected directly to the motor or the housing thereof.

The heat generated by the output stage is then transmitted via the base plate of the control unit to the motor or the motor housing.

The method presented is used to assemble or join a power unit, which comprises a motor and a control unit. The method is notably used for assembling a power unit of the type described above. To this end, a connection between the control unit and motor is achieved by means of shrink fitting.

Before joining the motor and control unit, a temperature difference can be effected between the motor and the control unit.

In one embodiment of the method, this temperature difference is effected by heating at least a portion of the motor. For example, the housing of the motor can be heated when it is connected to the control unit. If the control unit comprises a base plate, it is typically connected to the motor housing. Heating the motor allows the base plate to be received. After the motor housing cools, the shrink fit is achieved.

However, in principle, it is also possible to cool the control unit.

An induction coil can be used for heating the motor. The induction coil can be used to heat the motor, or those portions of the motor in which the temperature is to be controlled, in a non-contact manner.

The motor, or the housing of the motor, can be heated to between 90° C. and 180° C., for example to 120° C. This temperature is dependent on the dimensions of the motor and the control unit.

The joining apparatus for a power unit of an electric steering system presented, in which the power unit comprises a motor and a control unit, is used in particular for a power unit of the type described above. This apparatus comprises a first receptacle for the motor, a second receptacle for the control unit, and a moving device for varying the distance between the two receptacles. Moreover, a temperature control device is provided for effecting a temperature difference between the motor and the control unit.

The moving device can then be used to move, for example, the receptacle for the control unit and/or the receptacle for the motor, which is to say these are moved toward one another for the joining process.

In one embodiment, a temperature sensor, for example a pyrometer, can also be provided. This can then be used for non-contact temperature measurement. Prior to the joining process, the temperature can be measured so as to control the temperature as a function of the starting temperature. A temperature controller can, of course, also be provided.

An induction system can serve as the temperature control device.

Further advantages and embodiments of the invention will be apparent from the description and the accompanying drawings.

The above characteristics and those described below can, of course, be used not only in the respective described combinations, but also in other combinations or alone, without departing from the scope of the present invention.

The invention is shown in the drawings based on exemplary embodiments and will be described in detail hereinafter with reference to the drawings.

### BRIEF DESCRIPTION OF THE DRAWINGS

FIG. 1 is a schematic illustration of the embodiment of the power unit according to the invention.

FIG. 2 is an embodiment of the receptacle for the control unit.

FIG. 3 shows a detail of a joining apparatus.

### DESCRIPTION OF THE PREFERRED EMBODIMENTS

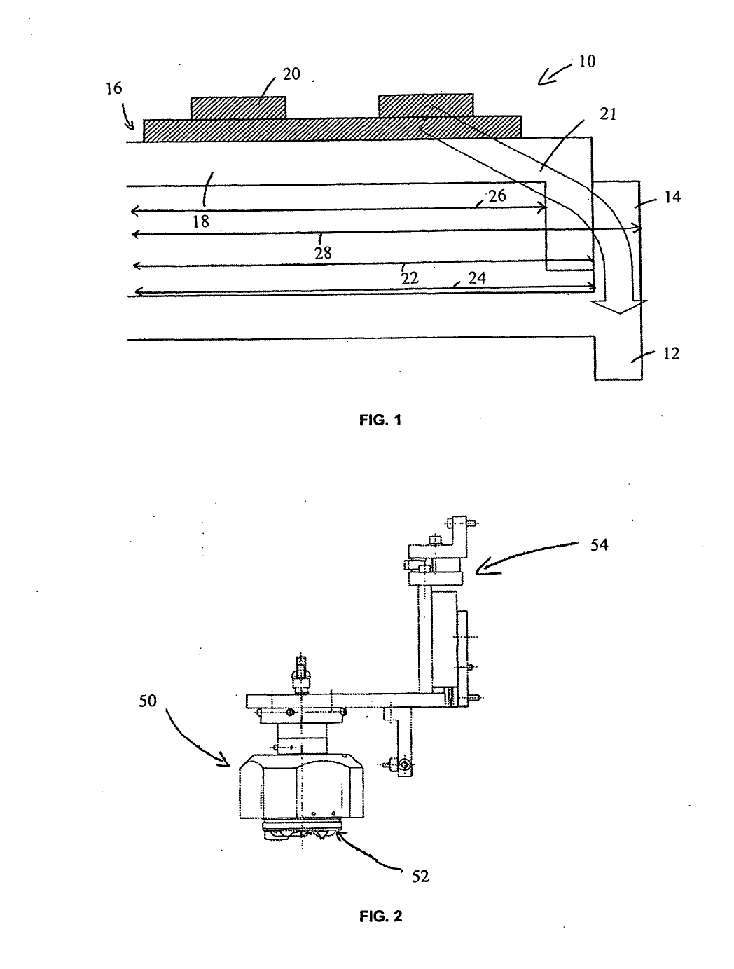

FIG. 1 shows an embodiment of a power unit, which is denoted in the overall by reference numeral 10. A housing 12 of a motor, which is not shown in detail, can be seen, the motor being used in an electric steering system. This motor housing 12 has an upwardly extending flange 14, which is closed as viewed from above and thus has a circular shape.

A control unit 16 having a base plate 18 and an output stage 20 located thereon is inserted in the motor housing 12. This base plate 18 is inserted into the motor housing 12 and connected thereto by shrink fitting. During operation, the output stage 20 generates heat and gives off the same to the motor housing 12, as indicated by the arrow 21.

The base plate 18 of the control unit 16 is dimensioned such that it has a larger diameter than the motor housing 12 in the region of the flange 14. Dimensioning the diameter of the base plate 18 at approximately 0.03 to 0.1 mm larger than the diameter of the motor housing is an obvious choice. Prior to inserting the base plate 18 in the motor housing 12, the motor housing is heated, for example to 120° C., so that the motor housing 12 expands and thereby the diameter of the motor housing 12 widens in the region of the flange 14. The base plate 18 is then inserted in the widened motor housing 12. During the subsequent cooling, the diameter of the motor housing 12 decreases and it is firmly pressed against the base plate 18 of the control unit 16, whereby the shrink fit is achieved.

Shrink fitting between the base plate 18 of the control unit and the motor flange 14 increases the pressing surface multifold. With shrink fitting, the thermal resistance from the control unit 16 to the motor is considerably lower than with a conventional screw assembly, due to the high pressing pressure and the large-surface-area thereof in the shrink fit. Thus, the heat can be dissipated very well from the output stage 20 when using shrink fitting. This also keeps the base temperature of the base plate 18 very low.

Because of the large mass of the motor as compared with that of the control unit 16, the motor constitutes a large thermal capacitance, which is able to take up very large amounts of heat from the control unit 16 over a short period of time. To be able to effectively utilize the heat capacity of the motor, the lowest possible heat transfer from the control unit 16 to the motor is required, which is achieved by the shrink fit.

FIG. 1 shows an embodiment in which the outside diameter 22 of the base plate 18 of the control unit is larger than the inside diameter 24 of the motor housing 12. By heating the motor housing 12, the base plate 18 of the control unit can be inserted inside the peripheral flange of the motor housing 12. Subsequent cooling of the motor housing produces the shrink fit.

It is, of course, also possible to configure the motor housing 12 and the base plate 18 so that the motor housing 12 can be inserted in the base plate 18 of the control unit, which is the opposite of that in the embodiment in FIG. 1. In this case, due to heating, the inside diameter 26 of the base plate 18 becomes greater than the outside diameter 28 of the motor housing 12 and can be placed thereon. The subsequent cooling of the base plate 18 then causes the shrink fit.

FIG. 2 shows a receptacle 50 for a control unit 52 as a component of the joining apparatus according to the invention. This receptacle has a shape that is adapted to the dimensions of the control unit, or of the base plate of the control unit 52, so that the control unit can be held securely in the receptacle 50.

Furthermore, a moving device 54 is shown, by which the receptacle 50 can be moved in the vertical direction.

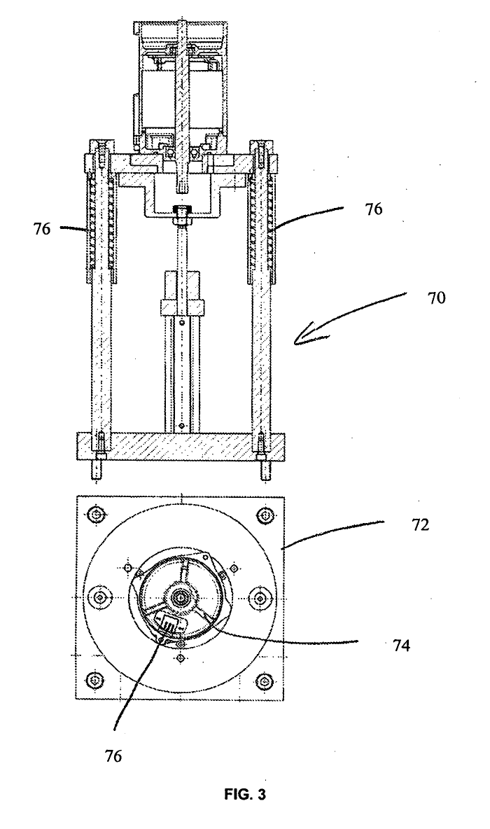

FIG. 3 shows a detail of the joining apparatus, which is denoted in the overall by reference numeral 70. A receptacle 72 for a motor 74 is apparent, having pins 76 provided on the underside for electrical contact. Moreover, guide rods 76 are provided, by which the receptacle 72 for the motor 74 can be displaced in the horizontal direction.

A description of a possible operating principle of the joining device is provided hereinafter:

First, the motor is placed in the motor receptacle. In order to orient the motor radially and axially relative to the control unit, or the base plate thereof, the motor is received in the motor receptacle via the outside diameter on the A bearing flange.

In the next step, the base plate or the ECU cover is inserted manually in the receptacle for the control unit. A configuration that prevents turning during insertion is achieved by way of the geometry of the ECU cover. Ball-sprung set screws retain the ECU cover in the receptacle and allow the receptacle to move out of the ECU in a substantially zero-force manner after the joining process. So as to transfer the angular positioning from the motor to the ECU receptacle, the receptacle is precentered to a position by a spring. These springs additionally provide the necessary tolerance to allow the pin pairs to mutually align with one another for the purpose of locating each other during joining.

This spring precentering is fixed in position in the next design adjustment (movable bus bar cover=mounting of the motor pins), and thus the bus bar will always perform the compensating movement so as to generate a consistent position between the motor and the ECU cover. This is necessary for further assembly/testing of the power pack. A spring-centered sliding block, which is rigidly screwed to the ECU cover receptacle, is used to compensate for axial misalignment (X/Y axis) and to center to the motor relative to the ECU cover. Misalignment results from the sum of the tolerances during production and assembly of the motor and ECU cover. The X/Y centering of the ECU cover relative to the motor via the sprung sliding block is made possible by the chamfer on the precision fit.

At this point, the machine takes over the joining process in a fully automatic manner, as soon as the operator pushes the start buttons and releases the light barrier.

The motor is then moved by a cylinder slightly above the inductor edge. This position has been established experimentally.

Then, the ECU cover is transported in rapid motion above the motor edge to a distance such as will exclude damage to the electronic components due to the inductance during heating.

Subsequently, temperature sensors are applied to the temperature-relevant locations of the motor. It is also possible to use pyrometers.

The temperature sensors are used to ensure that sufficient expansion takes place so as to enable zero-force joining and that no damage occurs due to overheating.

Using various stages (when using a pyrometer, the pyrometer controls the target values of target-value and time parameters), the induction system heats the joining region of the motor, which expands, allowing zero-force joining. The zero-force joining is necessary to allow the pin pairs to locate one another without constraints. After the pin pairs have completed the locating process, the sealing ring contacts the joining region.

To prevent damage to the parts when the end stops are hit, parameterizable shut-off of the retraction force is monitored by way of a force sensor, and the shaft is stopped when this is reached. The joining end position is monitored and evaluated by a parameterizable path/force window.

As soon as the joining region has dropped below a parameterizable temperature, if the target/actual evaluation was acceptable, the system moves into the neutral position and the joined parts can be removed. Otherwise, the operator must first acknowledge an error message, in order to remove the joined parts.

1. A power unit for an electric steering system, the power unit comprising a motor and a control unit, wherein the control unit is connected to the motor by means of shrink fitting.

2. The power unit according to claim 1, wherein the control unit is connected to a housing of the motor.

3. The power unit according to claim 2, wherein the housing is made of die cast aluminum.

4. A power unit according to claim 1, wherein the control unit comprises a base plate.

5. The power unit according to claim 4, wherein an output stage of the control unit is disposed on the base plate

6. A method for assembling a power unit comprising a motor and a control unit, in particular a power unit according to claim 1, wherein a connection between the control unit and the motor is achieved by means of shrink fitting.

7. The method according to claim 6, wherein prior to joining the motor and control unit, a temperature difference is effected between the motor and the control unit.

8. The method according to claim 7, wherein the temperature difference is effected by heating at least a portion of the motor.

9. The method according to claim 8, wherein an induction coil is used for heating the motor.

10. The method according to claim 8, wherein the motor is heated to between 90° C. and 180° C.

11. A joining apparatus for a power unit of an electric steering system, the power unit comprising a motor and a control device, in particular a power unit according to claim 1, comprising:
a first receptacle for the motor,
a second receptacle for the control unit,
a moving device for varying the distance between the two receptacles, and
a temperature control device for effecting a temperature difference between the motor and the control unit.

12. The joining apparatus according to claim 11, wherein a temperature sensor is further provided.

13. The joining apparatus according to claim 11, wherein an induction system is used as the temperature control device.

14. The method according to claim 9, wherein the motor is heated to between 90° C. and 180° C.

15. The joining apparatus according to claim 12, wherein an induction system is used as the temperature control device.

16. A method for assembling a power unit for an electric steering system comprising providing a motor and a control unit in the form of a power unit, and effecting a shrink fitting connection between the control unit and the motor.

17. The method according to claim 16, wherein prior to effecting the shrink fitting connection between the motor and the control unit, a temperature difference is effected between the motor and the control unit.

18. The method according to claim 17, wherein the temperature difference is effected by heating at least a portion of the motor.

19. The method according to claim 18, comprising providing an induction coil for heating the motor.

20. A joining apparatus for a power unit of an electric steering system, the power unit comprising a motor and a control device in the form of a power unit, the joining apparatus comprising:
a first receptacle for the motor,
a second receptacle for the control unit,
a moving device for varying the distance between the two receptacles, and
a temperature control device for effecting a temperature difference between the motor and the control unit.
